(19) United States
(12) Patent Application Publication
(10) Pub. No.: US 2021/0000570 A1
(43) Pub. Date: Jan. 7, 2021

(54) Custom Retaining and Suction Device

(71) Applicant: University of Washington, Seattle, WA (US)

(72) Inventors: Daniel C. Chan, Seattle, WA (US); Yen-Wei Chen, Seattle, WA (US); Pavel Vasilyuk, Chimacum, WA (US)

(21) Appl. No.: 16/917,618

(22) Filed: Jun. 30, 2020

Related U.S. Application Data
(60) Provisional application No. 62/869,252, filed on Jul. 1, 2019.

(51) Int. Cl. A61C 3/10; A61C 17/10; B33Y 80/00; A61C 9/00; B33Y 70/00

(52) U.S. Cl. CPC A61C 3/10; A61C 17/10; B33Y 80/00; C08L 55/02; B33Y 70/00; A61C 2201/00; A61C 9/0053

(57) ABSTRACT

A method of making a custom dental clamp, the method comprising producing a first clamp member using data from a scan of a patient's tooth, the first clamp member having at least one surface shaped to conform to a first surface of the tooth, producing a second clamp member using data from the scan, the scan clamp member having at least one surface shaped to conform to a second surface of the tooth, and connecting the first clamp member to the second clamp member with a resilient member.

### CROSS-REFERENCE TO RELATED APLPICATIONS

The present application claims the benefit of the filing date of U.S. Provisional Patent Application No. 62/869,252 filed Jul. 11, 2019, the entire disclosure of which is hereby incorporated herein by reference.

### BACKGROUND

During dental procedures, a flexible sheet, such as a rubber dam, is sometimes used to cover the tongue, gums, and cheeks of the patient. The sheet includes an aperture through which one or more teeth protrude such that the tooth or teeth are easily accessible by the dental worker. A dental clamp or rubber dam clamp is detachably coupled to the tooth near the base of the tooth to hold the sheet substantially flush against the gums so that the tooth is not covered.

Traditional dental clamps are mass produced, disposable metal clamps having two metal clamp members configured to be pressed against respective sides of the tooth. A resilient member extending between the clamp members provides a spring force to hold the clamp members against the tooth. The hard metal being pressed against the tooth and gums can cause discomfort or even damage to the patient.

3D dental imaging such as cone beam computed tomography (“CBCT”) and optical scanning is well on its way to becoming the new standard of dental care. 3D dentistry, at its most basic, involves developing a digital, 3D image of the mouth and skull. 3D dental images are most often used for diagnosis and treatment planning. Being able to see the mouth in three dimensions allows the dentist to better and more effectively formulate an approach to treat dental conditions.

Coupled with 3D imaging is the procedure of 3D printing. The global dental 3D printing market was worth US$903.0 million in 2016 and is estimated to be worth US$3,427.1 million by the end of 2025. From a geographic point of view, the global market will be dominated by North America. This regional market is estimated to account for a share of 41.9% in the global market by the end of 2025. Over the last decade there has been many advancements in 3D printing technology which included a decrease in costs and increase in accuracy.

Dental procedures often also involve the use of powered devices or high-speed handpieces such as drills or ultrasonic scalers. These tools can cause saliva to become an aerosol that is sprayed back towards the dental worker. This aerosol saliva has a high risk of spreading communicable diseases, such as COVID-19. A suction device can be used to reduce the amount of saliva, however the suction device is held by a dental worker and must be proximate the tooth, thus reducing visibility thereof and/or access thereto.

Electronic consoles, such as display consoles, often include ports to which external devices can be connected. Connecting to the port enables the external device to transmit data to or receive data from the electronic console. The port may also provide power so as to charge the external device.

In some examples, the port is illuminated to increase visibility to a potential user. The perimeter of the port is illuminated so as to indicate the shape and size of the port, enabling users to easily identify the type of port. In an example, the port is directly illuminated by one or more designated lights, such as LEDs. However, direct lighting may cause inconsistent intensity along the perimeter. Direct lighting also requires positioning the light proximate the port where space is limited.

### SUMMARY

As discussed above, scans of a patient's mouth, including scans of one or more teeth can be taken. The scans produces scan data such as 2D or 3D images of a patient's tooth. A custom dental clamp is made based on the scan data. Making the custom dental clamp comprises producing a first clamp member using the scan data, the first clamp member has at least one surface shaped to conform to a first surface of the tooth. It further comprises producing a second clamp member using the scan data, the second clamp member has at least one surface shaped to conform to a second surface of the tooth. The first clamp member and the second clamp member are connected by a resilient member. In some forms, the resilient member is integral with the first and second clamp members, meaning the resilient member, first clamp member, and second clamp member are all one piece.

In one embodiment, the first and second clamp members are produced by a 3D printer. In some forms, the resilient member is also produced by the 3D printer so as to be integral with the first and second clamp members.

In some embodiments, a light source, such as an LED, is connected to at least one of the first clamp member, the second clamp member, and the resilient member. The light source is oriented to illuminate the tooth. Alternatively or additionally, a camera, such as a wireless digital camera, is connected to at least one of the first clamp member, the second clamp member, and the resilient member.

In some forms, the dental clamp includes a port or barbed connector for detachably coupling to a suction system. The port is in fluid communication with one or more apertures in the dental clamp by an internal channel. Accordingly, fluid, such as saliva, is drawn into the aperture, through the channel, and then into the suction system to remove it from the patient's mouth.

Disclosed herein is a system for producing custom dental procedure appliances, the system comprising a 3D digital scan of a patient's dental anatomy, identifying a set of measurements from the 3D digital scan needed for a dental procedure appliance device based on the patient's dental anatomy, and a 3D printer which produces all or part of the dental appliance device based on the set of measurements.

In some forms of the system, the set of measurements is specific to an individual tooth of the patient's dental anatomy.

In some forms, the dental appliance device may serve as an anatomical guideline for complex restorative procedures (ex. cuspal replacement and/or core build-up).

In some forms, the dental appliance device is a rubber dam clamp.

In some forms, the dental appliance device is a rubber dam clamp with suctioning capability.

In some forms, the dental appliance device includes an at least one LED light source

In some forms, the dental appliance device includes a waterproof camera capable of wireless communication.

Also disclosed herein is a method comprising one or more elements as described and/or illustrated herein.

Further disclosed herein is a non-transitory computer-readable medium having computer-executable instructions stored thereon that, if executed by one or more processors of a computing device, cause the computing device to perform one or more steps as described and/or illustrated herein.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 is a front perspective view of a custom dental clamp according to example embodiments.

FIG. 2 is a side perspective view of the custom dental clamp of FIG. 1.

FIG. 3 is a front perspective view of a camera for use in the dental clamp of FIGS. 1 and 2.

FIG. 4 illustrates a mouth having dental clamps according to example embodiments.

FIG. 5 illustrates a mouth having a rubber dam secured by a dental clamp according to example embodiments.

FIG. 6 illustrates a mouth having a rubber dam secured by a dental clamp according to example embodiments.

FIG. 7 is a flow chart illustrating a method of making a using a dental clamp according to example embodiments.

FIG. 8 is a front perspective view of the dental clamp of FIGS. 1 and 2 with a cover portion of the resilient member removed.

FIG. 9 is a front perspective view of a custom dental clamp according to example embodiments.

### DETAILED DESCRIPTION

Exemplary implementations are described herein. It should be understood that the word “exemplary” is used herein to mean “serving as an example, instance, or illustration.” Any implementation or feature described herein as “exemplary” or “illustrative” is not necessarily to be construed as preferred or advantageous over other implementations or features. In the figures, similar symbols typically identify similar components, unless context dictates otherwise. The example implementations described herein are not meant to be limiting. It will be readily understood that the aspects of the present disclosure, as generally described herein, and illustrated in the figures, can be arranged, substituted, combined, separated, and designed in a wide variety of different configurations.

Additionally, directional terms used herein, such as “bottom,” “top,” “rear,” and “front” are used relative to the illustrated example. It is understood that the orientation of the dental clamps can change during use such that the bottom side is not always facing downward. In the shown embodiment, bottom is used to refer to the side facing the roots end of the tooth, top is used to describe the side facing in the chewing direction of the tooth, rear is used to describe a side facing the tooth and/or the front of the mouth, and rear is used to describe a side facing away from the tooth and/or towards the rear of the mouth.

Furthermore, the particular arrangements shown in the Figures should not be viewed as limiting. It should be understood other embodiments may include more or less of each element shown in a given Figure. Further, some of the illustrated elements may be combined or omitted. Yet further, an example embodiment may include elements not illustrated in the Figures. As used herein, with respect to measurements, “about” means +/−5%.

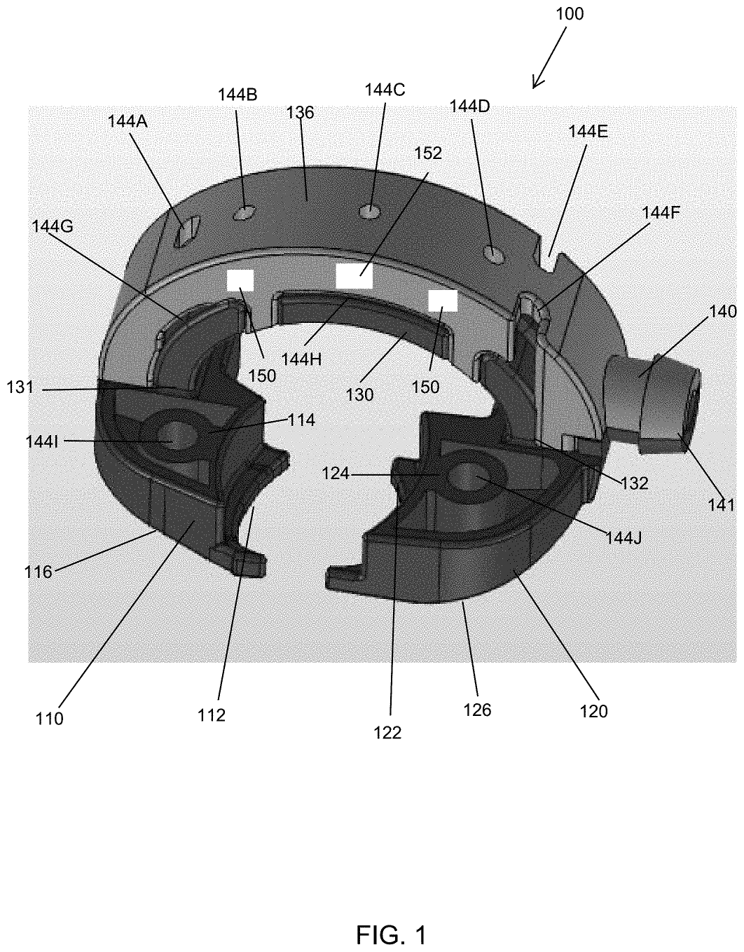

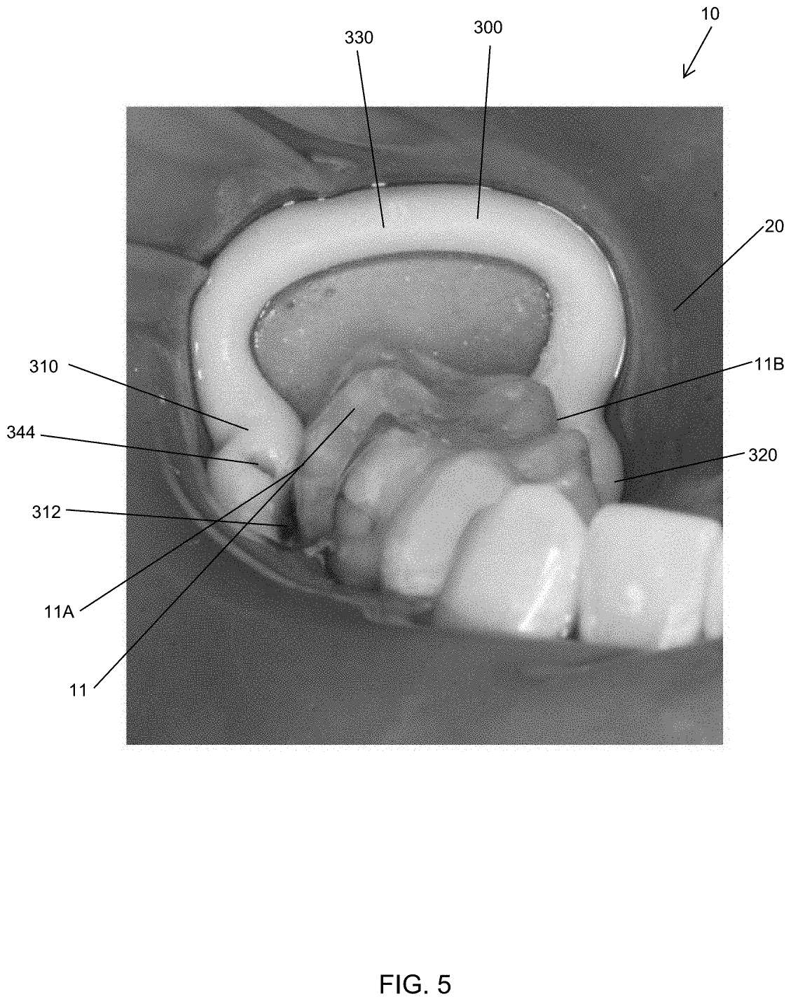

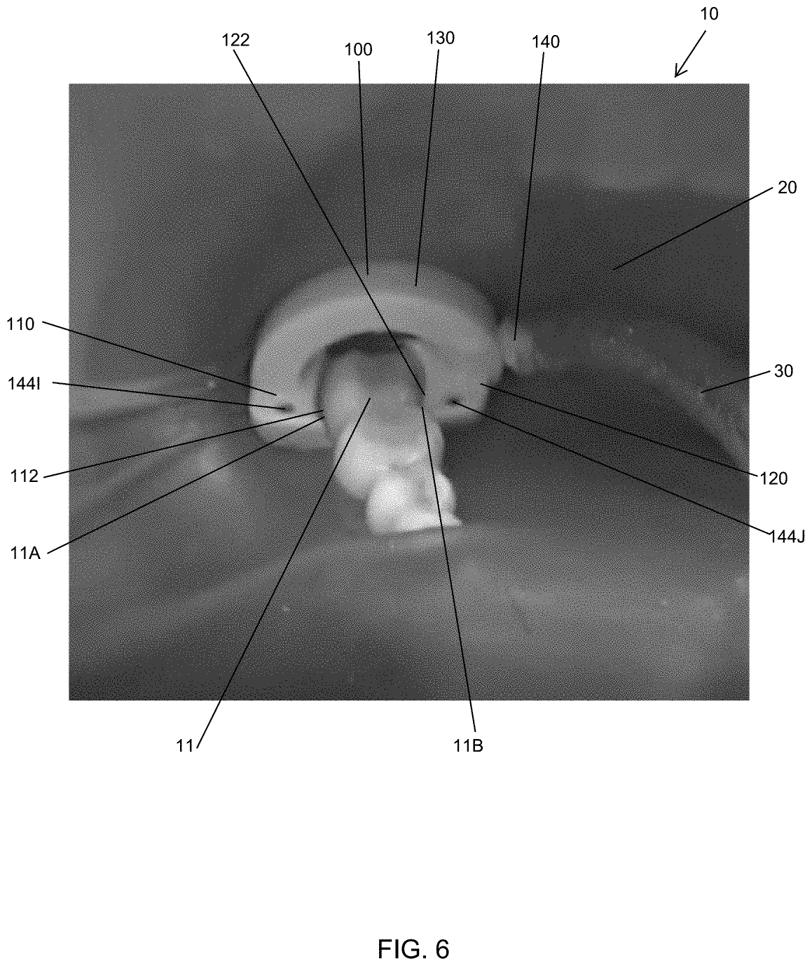

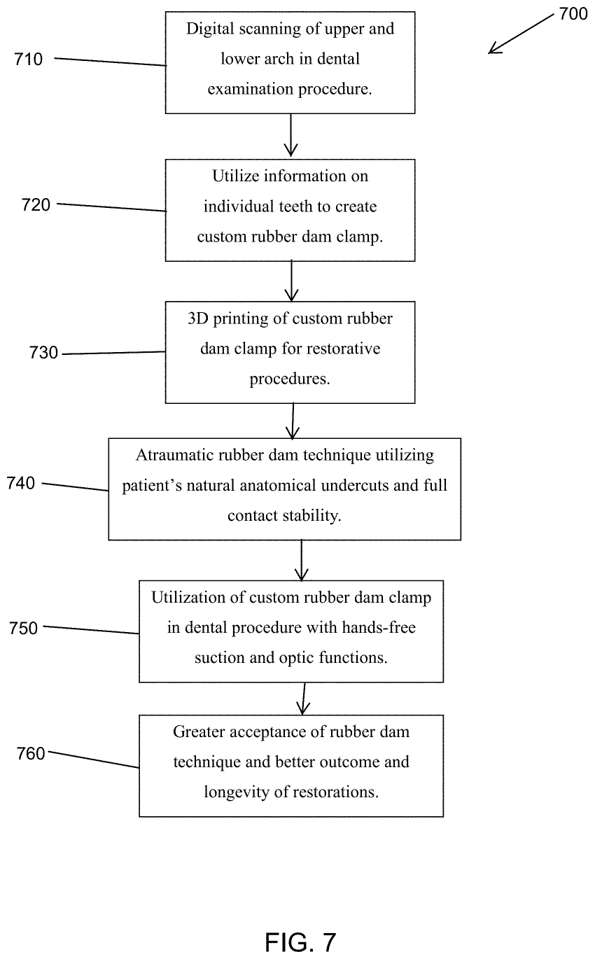

In one example, as outlined in FIG. 7, the system described herein includes, but is not limited to, the steps of: gathering data about an individual patient's dental anatomy through the use of some manner of 3D scan or some combination of other 2D or 1D scans that can then be used to generate a representative 3D dental anatomy of the patient. The 3D dental anatomy of the patient is then examined in an area where a dental procedure appliance may be used. Herein, a recurring example of a rubber dam clamp will be used as an illustrative example. In order to produce a custom-fitting rubber dam clamp for the patient, the target location for mounting the clamp will be identified in the 3D scan data, and measurements to create the rubber dam clamp generated from the target location. The measurements are used to tailor a generic or application-specific rubber dam clamp design, the tailored design is then fabricated using a 3D printer. In the case of a 3D printed rubber dam clamp, the rubber dam clamp may be fabricated with an internal channel to apply suction using a connection as shown in FIG. 1, 2, or 4 while in a position as shown in FIG. 5 or 6 throughout a procedure.

Several embodiments of the system may utilize 3D scans of patient's dental anatomy taken in past procedures, previous appointments, or other circumstances, or the system may use a 3D scan of patient's dental anatomy taken during the same appointment, solely for the purpose of the current procedure. The clamp may be comprised of suitable materials, either on their own or in combination, providing a clamp capable of adequate force to keep a rubber dam in place during a procedure, while also being pliable to avoid damage to tooth surface or causing pain along any contact with the gumline the clamp may have. The clamp material should also be inert to avoid any harm to patients if some fluid from the procedure is consumed it will not pose any danger to the patient. For the rubber dam clamp example herein, a material that is nontoxic, and compatible with 3D printing fabrication was used to fabricate the clamp.

In the case of a 3D printed rubber dam clamp, an individual clamp can be printed with images captured from the patient during the in-take examination and will be custom-made and unique. The clamp thus fashioned will be least traumatic to the surrounding soft tissue and patient acceptance will be greatly enhanced. Rubber dam clamp trauma during endodontic treatment has been shown to be a risk factor of bisphosphonate-related osteonecrosis of the jaw (Gallego, Lorena, et al.).

Several embodiments of the system may utilize on-site 3D printers to rapidly fabricate dental procedure appliances within the course of a patient's visit to a dental clinic for a procedure. Other embodiments of the system may produce dental procedure appliances at remotely-located 3D printers. For example, a patient in a rural setting may have to make more than one visit to a dental clinic, and the clinic may then forego an investment in a 3D printer, but instead send necessary information for fabricating a dental procedure appliance to some other vendor with a 3D printer, and the dental procedure appliance may be used in future clinic visits.

As shown in FIG. 1, the system may be used to produce a dental procedure appliance, for example, a rubber dam clamp. FIG. 1 further illustrates the rubber dam clamp with a barbed connection on one side for connection to suction, LED light sources, as well as a wireless digital camera. Some embodiments of the rubber dam clamp may be further customized to be used on either side of the patient's mouth by having two barbed connections, one on each side of the rubber dam clamp, while the body of the rubber dam clamp will still contain a channel that allows the vacuum of the suction to be applied elsewhere via another opening in the rubber dam clamp where suction would be applied. For example, the rubber dam clamp could be fabricated with only one barbed connection on one side, as in the figures, and leave the port open on the other side where suction will remove excess fluids during a procedure, or the rubber dam clamp may be fabricated with two barbed connection, and one may be removed depending on which side of the mouth the rubber dam clamp will be used on.

Currently, basic dental components, for example, rubber dam clamps, are not produced via 3D printing. Rubber dam procedure may be used in many different dental procedures for different reasons including, but not limited to at least one of the following: to hold a product in place against a tooth, such as a paste applied to a tooth for tooth-color resin restorations; to hold a suction line in place throughout a procedure for constant suction.

As shown in FIGS. 1, 2, and 3, a camera and LED lighting may be included in the dental procedure appliance, such as the example rubber dam clamp, during the fabrication of the appliance. Incorporating a camera and lighting would allow for a perspective view of a dental procedure that has not previously been available to those performing dental procedures. While not intended to be relied upon as a primary perspective view of a procedure, a camera view from a rubber dam clamp at the back of a patient's mouth is a helpful perspective at different points throughout dental procedures. The additional benefit of having a camera mounted within the patient's mouth is that the perspective is then fixed relative to the teeth in the mouth of the patient keeping the image steady and upright.

FIG. 6 shows a custom 3D printed rubber dam clamp used on a patient. The rubber dam clamp has a barbed hose fitting on one side for constant, hands-free suctioning throughout a procedure.

Such custom-made rubber dam clamp can be printed in a dental office with ease. For example, a patient may be measured for a custom rubber dam clamp as discussed herein in about 10 minutes, and fabrication by 3D printing may take 20 minutes from the beginning of the 3D printing process (after custom appliance measurements sent to 3D printer) to a finished and usable appliance. The design can be modified and adapted for specific clinical purposes, such as serving as a matrix for complex restorative procedures. Overall, the 3D printed rubber dam clamp can become mainstream in the dental world and can benefit the delivery of patient care and effectiveness of clinical time.

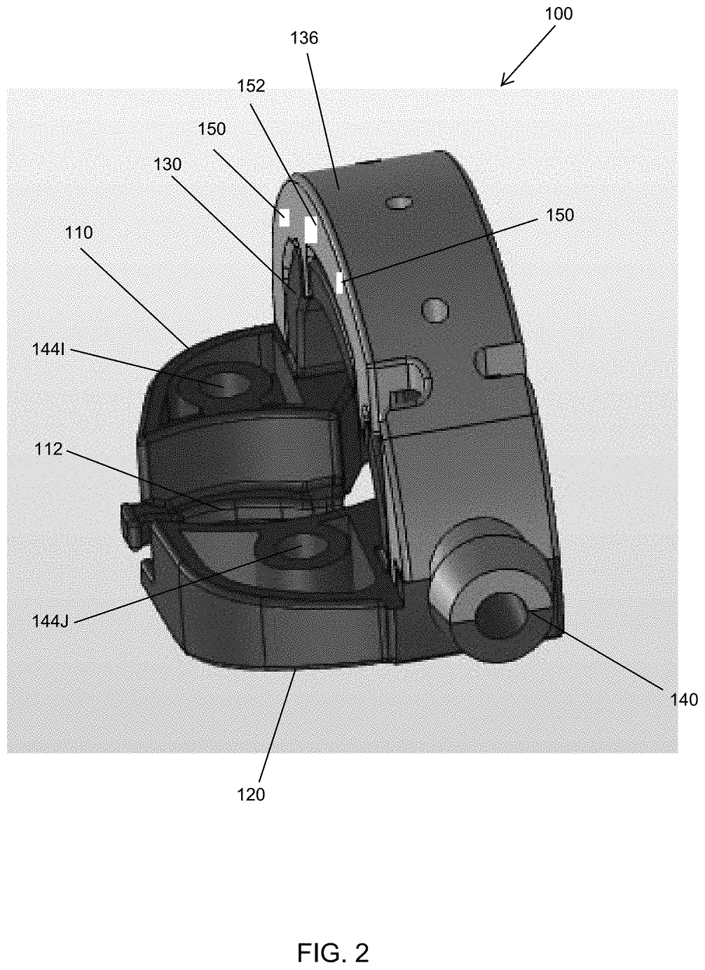

Turning now to the figures, FIGS. 1-2 illustrate a custom rubber dam clamp or dental clamp 100. The dental clamp 100 includes a first clamp member 110, a second clamp member 120, and a resilient member 130. The resilient member 130 is substantially arc shaped having a first end 131 coupled to the first clamp member 110 and a second end 132 coupled to the second clamp member 120. Therefore, the first clamp member 110 and the second clamp member 120 are connected to each other by the resilient member 130.

At least the first clamp member 110 and the second clamp member 120 are formed of a non-toxic material used in standard rapid prototyping machines, such as 3D printers. Example materials include acrylonitrile butadiene styrene, nylon, high-density polyethylene, polyethylene terephthalate, polycarbonate, or polyethylene terephthalate glycol.

In the shown embodiment, the resilient member 130 is integral with the first clamp member 110 and the second clamp member 120. In alternative embodiments, the resilient member is detachably coupled to the first clamp member 110 and the second clamp member 120.

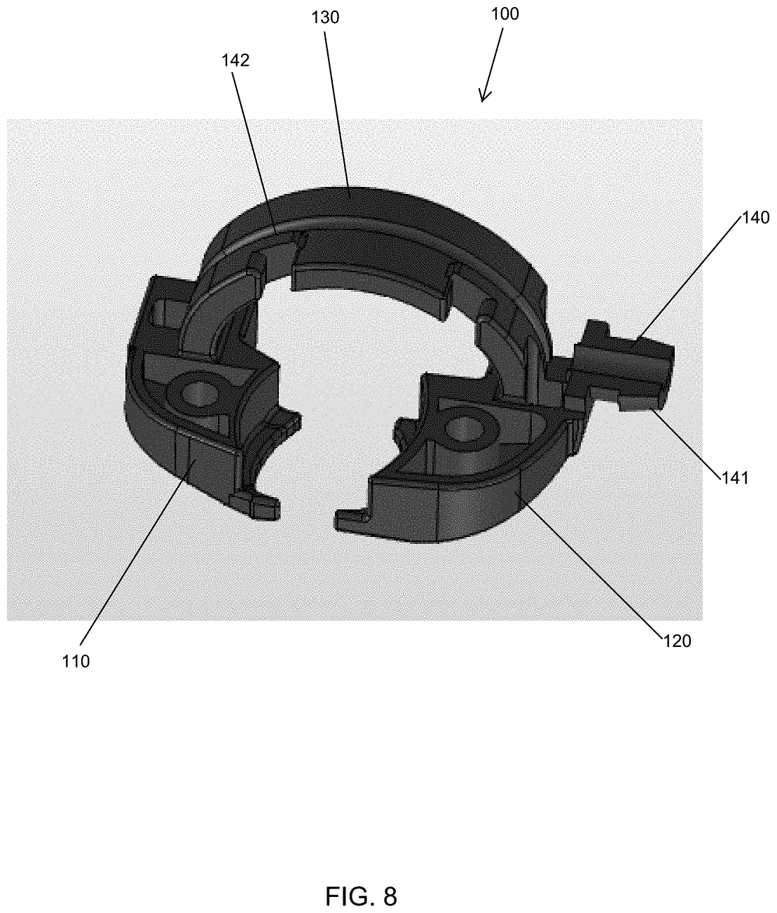

In some forms, the resilient member 130 includes a cover 136 detachably coupled thereto. The cover 136 at least partially encloses an internal channel 142 extending through the resilient member 130, as shown in FIG. 8.

The first clamp member 110 has a first surface 112 shaped to conform to at least one first surface of a patient's tooth. As described herein, the first clamp member 110 is custom made based on scan data of the tooth, and therefore the first surface is shaped to conform to a particular tooth. The first surface 112 has a concave shape so as to partially extend around the circumference of the tooth. The first clamp member 110 further includes a top surface 114 and a bottom surface 116, both of which are substantially perpendicular to the first surface 112. In some forms, the bottom surface 116 is shaped to conform to at least one surface of the patient's gums.

Similarly, the second clamp member 120 has a first surface 122 shaped to conform to at least one second surface of a patient's tooth. The second surface of the patient's tooth is substantially opposite the first surface of the patient's tooth. In operation, the dental clamp 100 is positioned such that the patient's tooth is between the first surface 112 of the first clamp member 110 and the first surface 122 of the second clamp member 120. As described herein, the second clamp member 120 is custom made based on scan data of the tooth, and therefore the first surface is shaped to conform to a particular tooth. The first surface 122 has a concave shape so as to partially extend around the circumference of the tooth. The first surface 122 faces the first surface 112 of the first clamp member 110. The second clamp member 120 further includes a top surface 124 and a bottom surface 126, both of which are substantially perpendicular to the first surface 122. In some forms, the bottom surface 126 is shaped to conform to at least one surface of the patient's gums.

As shown, the resilient member 130 is at least partially offset rearward from the first clamp member 110 and the second clamp member 120. Accordingly, the resilient member 130 is not positioned directly above the first surfaces 112, 122 thereof. In operation, this offset allows better access to the tooth by the dental worker.

The dental clamp 100 includes a barbed connector or port 140. The port 140 is configured to detachably couple to a hose or nozzle of a suction system, thus applying hands free suction to the area around the tooth. For example, the port 140 includes a barb 141 sized to deform a standard sized rubber hose, thus forming a friction fit therewith. In alternative embodiments, the port 140 includes threads or a quick connect structure for detachably coupling to the suction system.

In the shown embodiment, the dental clamp 100 includes a single port 140 on one side of the dental clamp 100. In alternative embodiments, the dental clamp 100 further includes a second port 140 on the opposite side thereof. The two port dental clamp 100 can be more easily used on either side of the patient's mouth by allowing the suction system to be connected on the lingual side of the tooth. In the shown form, the port 140 is on the resilient member 130. In alternative forms, the port 140 is on one of the first clamp member 110 and the second clamp member 120.

One or more apertures 144A-144J are extend through at least one surface of the dental clamp 100. The apertures 144A-144J are in fluid communication with the port 140 through an internal channel 142 (see FIG. 8). Apertures 144A-144H are in the resilient member 130. As shown, the apertures 144A-144H are in the top and front surface thereof Alternatively or additionally, apertures can be positioned in the bottom or rear surfaces of the resilient member 130.

Apertures 144I-144J are in the first clamp member 110 and second clamp member 120 respectively. The apertures 144I-144J extend completely though the clamp members 110, 120, having openings on both the top surface and bottom surfaces thereof. In alternative embodiments, the apertures 144I-144J only extend through the top surface of the clamp members 110, 120. In some forms, the first clamp member 110 and/or second clamp member 120 include additional apertures in at least one side surface thereof.

In operation, the apertures 144I-144J are used to place the dental clamp 100. Forceps are used to grip the dental clamp 100 by placing a first tine in the aperture 144I and a second tine in the second aperture 144J. The forceps are then spread, deforming the resilient member 130 and increasing the distance between the first surfaces 112, 122. The dental clamp 100 is then positioned around the tooth such that the first surface 112 of the first clamp member 110 is proximate a first surface of the tooth and the first surface 122 of the second clamp member 120 is proximate a second surface of the tooth. The forceps are then released. The resiliency of the resilient member 130 presses the first clamp member 110 and the second clamp member 120 towards each other such that the first surface 112 and the first surface 122 are brought into contact with the tooth.

In some embodiments, the dental clamp 100 includes one or more light sources 150. Example light sources 150 include light emitting diodes (“LEDs”) such as chip on board LEDs. As shown, the light sources 150 are connected to the front surface 134 of the resilient member 130. Alternatively or additionally, the light sources 150 are connected to the bottom surface of the resilient member 130 and/or to one or both of the first clamp member 110 and the second clamp member 120.

In some forms, the dental clamp 100 further includes one or more cameras 152. The camera 152 is a wireless digital camera. The camera 152 records video data of the tooth and transmits the video data to a computer system. The computer system includes a display proximate the patient so as to be readily visible to the dental worker. The camera 152 can therefore provide an additional view of the tooth which may be less obstructed by dental equipment and/or hands, allowing the dental worker to work more precisely.

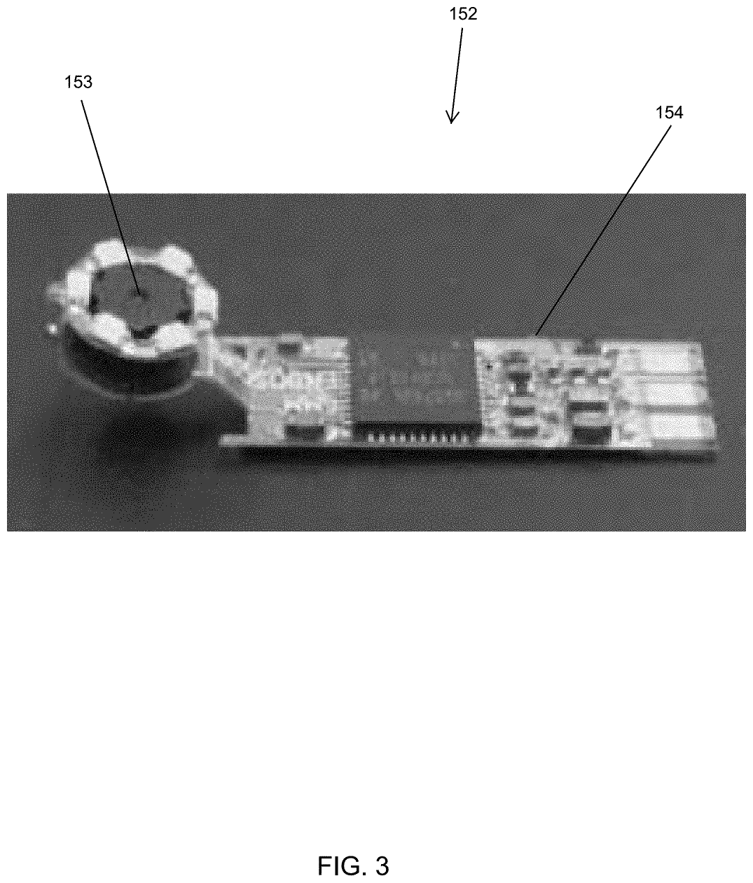

FIG. 3 illustrates an example camera 152 for use in the dental clamp 100. The camera 152 includes a lens 153 and control circuity 154. The control circuitry 154 includes a processor, memory, a wireless transmitter, and a battery. In operation, the camera 152 is coupled to the dental clamp 100 such that the lens 153 faces the tooth. In some forms, the camera 152 is mounted to the front surface or bottom surface of the resilient member 130. In a preferred form, the camera 152 is at least partially water proof so as to reduce the risk of malfunction as a result of exposure to saliva. In some forms, the camera 152 is detachably coupled to the dental clamp 100. After the procedure, the camera 152 can be detached from the dental clamp 100 and cleaned so as to be used with different dental clamps 100 in different procedures. Accordingly, the dental clamp 100 is disposable, but the camera 152 is reusable.

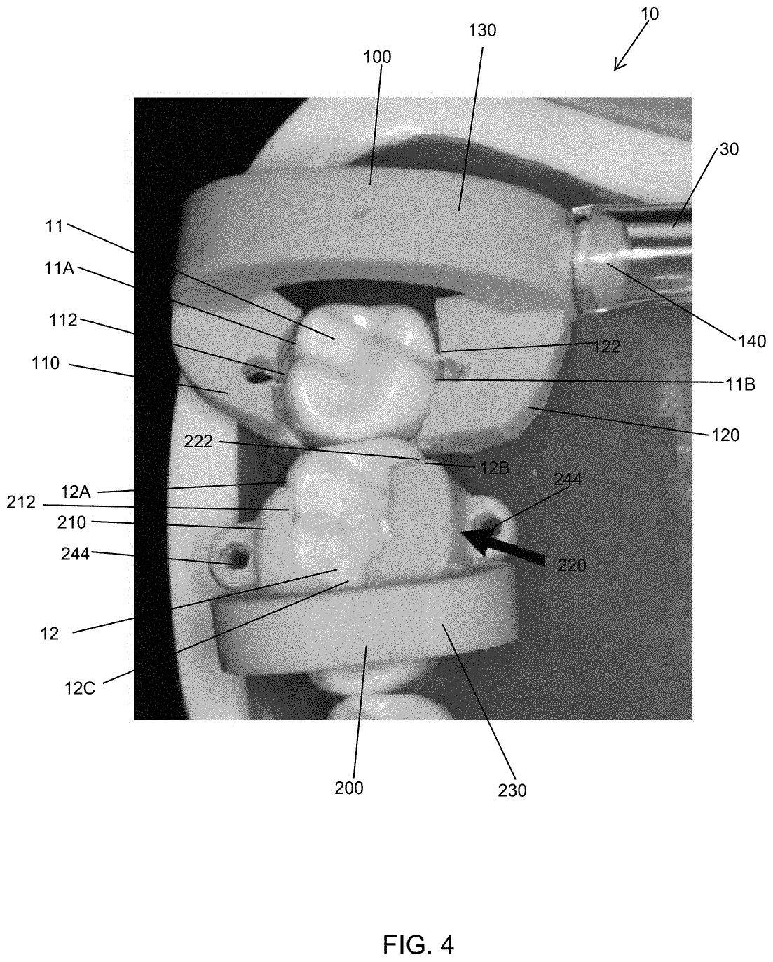

FIG. 4 illustrates a mouth 10 having a first tooth 11 and a second tooth 12. The dental clamp 100 is detachably coupled to the first tooth 11 with the first surface 112 of the first clamp member 110 in contact with a first surface 11A of the first tooth 11, and the first surface 122 of the second clamp member 110 in contact with a second surface 11B of the first tooth 11. A hose 30 of a suction system is detachably coupled to the port 140 so as to provide suction through the apertures as described above.

A second dental clamp 200 is detachably coupled to the second tooth 12. The second dental clamp 200 includes a first clamp member 210 and a second clamp member 220 connected by a resilient member 230. The first clamp member 210 has a first surface 212 in contact with a first surface 12A of the second tooth 12. The second clamp member 220 has a first surface 222 in contact with a second surface 12B of the second tooth 12. The second clamp 200 is produced based on scan data of the second tooth 12 such that the first surfaces 212, 222 are shaped to conform to the respective surfaces 12A, 12B of the second tooth 12.

The first clamp member 210 and second clamp member 220 extend at least partially over the top surface 12C of the second tooth 12. As shown, the second dental clamp 200 does not include a port for coupling to the suction system. The lack of a port and internal channel allows the second dental clamp 200 to be smaller than the first dental clamp. In operation, the first dental clamp 100 is positioned on the tooth 11 being operated upon by the dental worker. The second dental clamp 200 is positioned on a nearby tooth 12 to aid in securing the sheet or rubber dam against the patient's gums.

FIG. 5 illustrates the mouth 10 with a rubber dam or flexible sheet 20 covering at least part of the tongue, gums, and cheeks. The flexible sheet 20 includes an aperture 21 through which a plurality of teeth, including a first tooth 11, extend through. The flexible sheet 20 is held against the gums by a rubber dam clamp or dental clamp 300.

As with the embodiments described above, the dental clamp 300 includes a first clamp member 310 and a second clamp member 320 connected by an arc shaped resilient member 330. The first clamp member 310 includes a first surface 312 which in operation is pressed against a first surface 11A of the first tooth 11. The second clamp member similarly has a first surface pressed against the second surface 11B of the first tooth 11. The first surfaces of the first clamp member 110 and second clamp member 120 are produced in accordance with scan data of the tooth 11. Accordingly, the first surfaces are shaped to conform to respective surfaces 11A, 11B of the first tooth 11.

The dental clamp 300 does not include a port or internal channel for coupling the dental clamp 300 to a suction system. However, the dental clamp 300 does include apertures 344 through the first clamp member 310 and second clamp member 320. The apertures 344 are used for installing the dental clamp 300, as described above.

FIG. 6 illustrates the mouth 10 with the flexible sheet 20. The flexible sheet 20 is held against the gums by the dental clamp 100 described above detachably coupled to the first tooth 11. A hose 30 of a suction system. For illustrative purposes, water is being added to the mouth 10. As shown, the water is being sucked through the apertures, flowing through the channel to the port, and is then being removed from the mouth 10 by the hose 30.

The custom dental clamps described herein can be made and used by the method 700 shown in FIG. 7. The method 700 includes digitally scanning 710 at least a portion of a patient's mouth including at least one tooth. In some forms, the entire mouth is scanned using a CBCT scanner, x-ray machine, or other standard dental scanner. Alternatively, only a portion of the mouth containing the tooth is scanned, such as by an intraoral scanner. The scanning produces digital scan data which is transmitted to a computer. The digital scan data may include 3D or 2D scan data, such as a 3D or 2D image of the tooth.

The scan data is utilized 720 to produce a digital model of a custom dental clamp. The dental clamp includes at least one surface shaped to conform to a first surface of the tooth and at least one surface shaped to conform to a second surface of the tooth as described above.

The dental clamp is then produced 730 using the digital model. In one embodiment, the dental clamp is produced 730 on site by a rapid prototyping device, such as a 3D printer. Accordingly, the dental clamp is produced while the patient waits such that the scanning and the dental procedure may be performed during the same dental appointment. In alternative embodiments, the scanning 710 is done in advance such that the dental clamp can be produced 730 before the appointment for performing the dental procedure.

It is understood that producing 730 the dental clamp includes producing the first clamp member, producing the second clamp member, and connecting the first clamp member to the second clamp member by the resilient member. In some forms, the first clamp member, second clamp member, and resilient member are all produced as a single integral unit. Producing 730 may additionally include steps of connecting one or more light sources and/or a camera to at least one of the first clamp member, the second clamp member, and the resilient member.

The dental clamp is utilized 740 in an atraumatic fashion. By shaping the dental clamp to conform to the surfaces of the tooth, the force between the dental clamp and the tooth is spread across a large surface area. This differs from traditional rubber dam clamps in which the clamp force is concentrated along one or a few points of contact between the rubber dam clamp and the tooth. This reduces the risk of trauma to the tooth. Additionally, the increase in surface area enables a smaller clamping force to achieve the necessary friction with the tooth to secure the flexible sheet in position against the gums of the patient. This reduction in clamping force further reduces the risk of trauma to the tooth.

In some forms, the dental clamp is further utilized 750 to apply hands free suction and/or improved optics to the area around the tooth. As described above, the dental clamp may include a port for detachably coupling to a suction system. The port is in fluid communication with one or more apertures in the dental clamp through which saliva and other fluid are removed from the area around the tooth. The dental clamp may also include one or more light sources and/or a digital camera to provide improved visibility of the tooth for the dental worker.

The use of the custom dental clamp allows for greater acceptance 760 of the use of rubber dams. The reduction in the chance of trauma to the tooth and the reduction in discomfort of the patient enable rubber dams to be used in procedures where prior art dental clamps would not be used. This allows for higher visibility, and thus better outcomes from the dental procedures. This further serves to reduce exposure of the dental worker to aerosol saliva, thus reducing the risk of spreading communicable diseases from the patient to the dental worker.

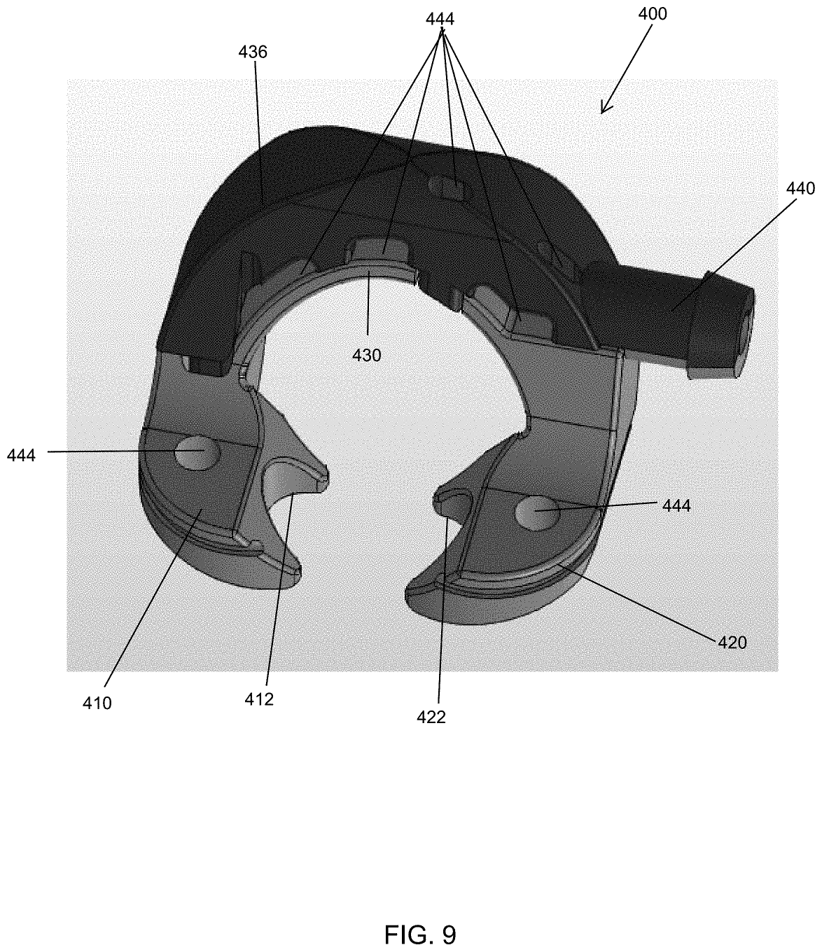

FIG. 9 illustrates a custom dental clamp 400. The dental clamp 400 is substantially similar to the dental clamp 100 described above. Unless specified otherwise, elements of the dental clamp 400 having reference numerals sharing the same last two as elements of the dental clamp 100 are substantially similar.

The dental clamp 400 includes a first clamp member 410 and a second clamp member 420 connected by an arc shaped resilient member 430. The first clamp member 410 includes a first surface 412 shaped to conform to a first surface of a tooth. The second clamp member 420 includes a second surface 422 shaped to conform to a second surface of the tooth. As in the embodiments above, the dental clamp 400 is produced based on scan data of the tooth.

The dental clamp 400 is shaped for use on a premolar or bicuspid tooth. In contrast, the dental clamp 100 described above is shaped for use on a molar. As shown, the first surfaces 412, 422 are substantially arc shaped so as to extend around the substantially round sidewall of a premolar tooth. In contrast, the first surfaces 112, 122 of the dental clamp 110 have a more elongated shape so as to conform to the sides of a molar tooth.

Additionally, the resilient member 430 of the dental clamp 400 is taller than the resilient member 130 of the dental clamp 100. Since the premolars are further forward in the mouth than the molars, there is additional clearance between the top and bottom jaw of an open mouth proximate the premolars. Accordingly, there is room for a taller resilient member 430. The use of a taller resilient member 430 provides additional visibility and access to the tooth.

The dental clamp 400 includes a port 440, internal channel (not shown), and a plurality of apertures 444 for providing a hands-free connection to a suction system. The shown embodiment has a single port 440 connected to one side of the resilient member 430. In alternative forms, the dental clamp 400 includes a second port 440 on a second side thereof, better enabling use of the dental clamp on either side of the patient's mouth.

The particular arrangements shown in the Figures should not be viewed as limiting. It should be understood that other implementations may include more or less of each element shown in a given Figure. Further, some of the illustrated elements may be combined or omitted. Yet further, an exemplary implementation may include elements that are not illustrated in the Figures. Additionally, while various aspects and implementations have been disclosed herein, other aspects and implementations will be apparent to those skilled in the art. The various aspects and implementations disclosed herein are for purposes of illustration and are not intended to be limiting, with the true scope and spirit being indicated by the following claims. Other implementations may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations.

What is claimed:

1. A method of making a custom dental clamp, the method comprising:
producing a first clamp member using data from a scan of a patient's tooth, the first clamp member having at least one surface shaped to conform to a first surface of the tooth;
producing a second clamp member using data from the scan, the scan clamp member having at least one surface shaped to conform to a second surface of the tooth; and connecting the first clamp member to the second clamp member with a resilient member.

2. The method of claim 1 wherein producing the first clamp member and the second clamp member comprises 3D printing the first clamp member and the second clamp member.

3. The method of claim 1 wherein connecting the first clamp member to the second clamp member comprises producing the resilient member integrally with the first clamp member and the second clamp member.

4. The method of claim 1, further comprising producing a port on at least one of the first clamp member, the second clamp member, and the resilient member, wherein the port is in fluid communication with an aperture in the first clamp member.

5. The method of claim 1, further comprising coupling a light source to at least one of the first clamp member, the second claim member, and the resilient member.

6. The method of claim 1, further comprising coupling a camera to at least one of the first clamp member, the second clamp member, and the resilient member.

7. The method of claim 1 wherein producing the first clamp member comprises producing the first clamp member from a material selected from a group consisting of acrylonitrile butadiene styrene, nylon, high-density polyethylene, polyethylene terephthalate, or polyethylene terephthalate glycol.

8. The method of claim 1 wherein connecting the first clamp member to the second clamp member comprises producing an arc shaped resilient member integral with the first clamp member and the second clamp member.

9. The method of claim 1 wherein producing the first clamp member using data from the scan of the patient's tooth comprises producing the first clamp member using a 3D image of the tooth generated from the scan.

10. A dental clamp comprising:
a first clamp member having at least one surface shaped to conform to a first surface of a tooth;
a second clamp member having at least one surface shaped to conform to a second surface of the tooth;
a resilient member connecting the first clamp member to the second clamp member.

11. The dental clamp of claim 11 further comprising a port in fluid communication with an aperture in the first clamp member.

12. The dental clamp of claim 12 further comprising a port in fluid communication with an aperture in the resilient member.

13. The dental clamp of claim 11 wherein the first clamp member, the second clamp member, and the resilient member are integral with each other.

14. The dental clamp of claim 11 further comprising a camera coupled to at least one of the first clamp member, the second clamp member, and the resilient member.

15. The dental clamp of claim 11 further comprising at least one light source coupled to at least one of the first clamp member, the second clamp member, and the resilient member.

16. The dental clamp of claim 11 wherein the at least one surface of the first clamp member and the at least one surface of the second clamp member face each other.

17. The dental clamp of claim 11 wherein the first clamp member and the second clamp member comprise a material selected from a group consisting of acrylonitrile butadiene styrene, nylon, high-density polyethylene, polyethylene terephthalate, or polyethylene terephthalate glycol.

18. The dental clamp of claim 11 wherein the resilient member is substantially arc shaped.

19. The dental clamp of claim 11 wherein the first clamp member has a second surface substantially normal to the at least one surface and wherein the second surface includes an aperture.

20. A rubber dam clamp comprising:
a custom 3D printed body having an internal channel;
a barbed connector, wherein the barbed connector is connected to at least one opening in the body by the internal channel.

21. The rubber dam clamp of claim 21 further comprising an LED light source.

22. The rubber dam clamp of claim 21 further comprising a digital camera.
